(19) United States
(12) Patent Application Publication
(10) Pub. No.: US 2026/0326657 A1
(43) Pub. Date: Oct. 22, 2026

(54) REAR-VIEW SYSTEM WITH REAR CAMERAS

(71) Applicant: SAFETY TECH, Brignais (FR)

(72) Inventors: Jérome SENESCHAL, Farnay (FR); Arnaud CHOPARD LALLIER, Grenoble (FR); Claude CHATEY, Saint Laurent d'Agny (FR); Yvan TERRASSON, Echalas (FR)

(73) Assignee: SAFETY TECH, Brignais (FR)

(21) Appl. No.: 19/109,830

(22) PCT Filed: Sep. 7, 2023
(86) PCT No.: PCT/FR2023/051344

§ 371 Date: May 13, 2025

(30) Foreign Application Priority Data
Sep. 7, 2022 (FR) FR2208939

(51) Int. Cl. B60Q 1/00; B60R 11/04

(52) U.S. Cl. CPC B60Q 1/0023; B60R 11/04; B60R 2300/107; B60R 2300/605; B60R 2300/70; B60R 2300/8026

(57) ABSTRACT

A rear-view system for a towing vehicle that is able to cooperate with a trailer attached to the towing vehicle so as to be rotatably movable, the rear-view system including: two lateral cameras; two rear cameras; two lateral screens; a control unit configured to display the images from each lateral camera on a corresponding lateral screen, the control unit also being configured to display the image from a rear camera rather than the image of a lateral camera on one of the two sides when the trailer, which is attached so as to be rotatably movable, extends on the opposite side with respect to the longitudinal axis.

### FIELD OF THE INVENTION

The present invention relates to a rear-view system with at least two lateral cameras and two rear cameras.

### PRIOR ART

It is known to use a rear-view system to replace the lateral rear-view mirrors of a vehicle. This arrangement is interesting for an articulated vehicle such as a truck comprising a towing vehicle and a trailer mounted mobile in rotation, each lateral rear-view mirror being able to be replaced by a camera and a screen.

The driver sees the areas near the lateral sidewalls of the trailer when the truck is moving in a straight line, that is to say when the trailer is aligned with the towing vehicle.

When turning or maneuvering, part of the rear view is obscured by the trailer because the towing vehicle and the trailer are no longer aligned.

One solution could be to add, independently of the rear-view system, other cameras coupled with additional screens disposed inside the cabin.

However, this solution is impractical because it becomes difficult for the driver to monitor several screens at once when turning or maneuvering.

The present invention aims to resolve all or part of the drawbacks mentioned above.

### Disclosure of the Invention

To this end, the present invention relates to a rear-view system for a towing vehicle capable of cooperating with a trailer mounted mobile in rotation on the towing vehicle, the rear-view system comprising:
two lateral cameras, each lateral camera being configured to be attached on a corresponding side of the towing vehicle relative to a longitudinal axis of the towing vehicle,
two rear cameras, each rear camera being configured to be attached to a corresponding rear area of the towing vehicle, each rear area being located on a corresponding side relative to the longitudinal axis, each rear camera being located lower than a load support tray of the trailer when the towing vehicle and the trailer cooperate and drive on flat horizontal ground,
two lateral screens, each lateral screen being configured to be attached to the towing vehicle so as to be visible from a cockpit of the towing vehicle,
a control unit configured to display the images from each lateral camera on a corresponding lateral screen, the control unit being further configured to display the image from a rear camera instead of the image from a lateral camera of one of the two sides when the trailer, which is mounted mobile in rotation, extends on the opposite side relative to the longitudinal axis, an extension direction of the trailer having a deviation angle greater than a limit value relative to the longitudinal axis of the towing vehicle.

The control unit allows the lateral cameras to be displayed when the towing vehicle and the trailer are aligned along the longitudinal axis and when the trailer is slightly deviating.

In this case, the trailer does not impair vision since the lateral cameras film the sidewalls of the trailer on each side. In addition, the front of the trailer facing the rear of the towing vehicle does not obscure part of the field of view of the lateral cameras. The rear cameras are therefore not used.

The field of view of each lateral camera corresponds to an angle of rear lateral view relative to the towing vehicle moving in the forward direction along the longitudinal axis.

When the towing vehicle turns or during a maneuver, a deviation angle appears between the extension direction of the trailer and the longitudinal axis of the towing vehicle.

Beyond the limit value of the deviation angle on one side of the longitudinal axis, the control unit displays the image from the rear camera on the opposite side.

In fact, on the side of the deviation, the sidewall of the trailer remains visible and takes up more and more space in the field of view of the lateral camera.

On the other hand, on the other side, the sidewall of the trailer is less and less visible until it disappears from the field of view of the lateral camera. The front of the trailer above the load support tray may also partially obscure the field of view of the lateral camera.

The control unit then changes the display and the rear camera makes visible a field of view hidden by the front of the trailer for the lateral camera. The rear camera also makes visible an area that the trailer would occupy if there were no deviation.

If a pedestrian or other vehicle is in this area, it becomes visible on the corresponding lateral screen. The camera change operated by the control unit therefore improves safety and facilitates turns and maneuvers.

When the turn or maneuver is completed and when the deviation angle is again less than the limit value, the control unit stops displaying the image from the rear camera.

According to one embodiment, when the deviation angle is greater than the limit value, the control unit displays the image from the rear camera instead of the image from the corresponding lateral camera. According to this embodiment, the control unit stops displaying the image from the rear camera and displays the image from the lateral camera again when the deviation angle is again less than the limit value. According to this embodiment, the same display area of each lateral screen makes it possible to display either the image from the rear camera or the image from the corresponding lateral camera.

According to another embodiment, when the deviation angle is greater than the limit value, the control unit displays the image from the rear camera instead of a part of the image from the corresponding lateral camera, which is then truncated compared to the image displayed when the deviation angle is less than the limit value. When the deviation angle is again less than the limit value, the control unit stops displaying the image from the rear camera and again displays the untruncated image from the corresponding lateral camera. According to this embodiment, the same display area of each lateral screen makes it possible to display both a truncated image from the lateral camera and the image from the rear camera when the deviation angle is greater than the limit value.

According to yet another embodiment, when the deviation angle is greater than the limit value, the control unit displays the image from the rear camera in addition to the image from the corresponding lateral camera, and simply stops displaying the image from the rear camera when the deviation angle becomes less than the limit value. According to this embodiment, each lateral screen comprises a display area dedicated to the rear camera.

According to one aspect of the invention, the control unit comprises in memory an algorithm for recognizing a particular entity such as a pedestrian, another vehicle or recognizable obstacle considered dangerous or vulnerable. The rear-view system can comprise an audible or visual warning device to inform the driver in the event of recognition of at least one particular entity. This arrangement improves safety.

The terms “front” and “rear” are to be understood as being defined in relation to the forward direction of travel of the towing vehicle and of the trailer when they cooperate. For the trailer, these terms are defined in relation to the extension direction of the trailer and, for the towing vehicle, in relation to the longitudinal axis.

According to one aspect of the invention, optionally, the control unit can be configured so that at least one additional criterion must be met for the image change from the lateral camera to the rear camera.

Preferably, an additional criterion is that the towing vehicle is driving in the backward direction.

The rear-view system is in this case reserved for maneuvers in the backward direction and the camera change does not occur when driving in the forward direction during tight turns. This arrangement is interesting in the sense that driving in the forward direction remains identical for the driver who constantly sees the images from the lateral cameras.

An additional criterion can also be a speed slower than the speed limit. Preferably, the speed limit is 30 km/h.

According to one aspect of the invention, the trailer comprises a coupling bolt attached to the load support tray and oriented downwards. The towing vehicle comprises a fifth wheel arranged to cooperate with the coupling bolt.

The expression “located lower than a load support tray” means that, directly above each rear camera, the load support tray is above the rear camera.

The terms “horizontal” and “vertical” and their derivatives are defined when the towing vehicle and the trailer cooperate and drive on flat horizontal ground.

According to one aspect of the invention, the limit value is comprised between 5 and 30°. Preferably, the limit value can be modified by parameterizing the control unit.

According to one aspect of the invention, each lateral camera is disposed on or provided in a lateral part of a body of the towing vehicle. Each rear camera is provided in a rear part of the body of the towing vehicle. Each lateral part extends substantially parallel to the longitudinal axis and each rear part extends transversely to the longitudinal axis.

In the present text, an articulated vehicle is a vehicle comprising the towing vehicle and the trailer mounted mobile in rotation on the towing vehicle. It can be a truck or any other type of articulated vehicle.

According to one aspect of the invention, each lateral screen comprises a user interface for forcing the display of the image from the rear camera in addition to the image from the lateral camera or instead of all or part of the image from the lateral camera. Without user intervention, the display change is carried out automatically by the control unit.

According to one aspect of the invention, the control unit is configured to control the presence of the trailer from the images from the rear cameras.

According to one aspect of the invention, the rear cameras can be used by the control unit as a reversing camera in the absence of a trailer.

According to one aspect of the invention, when the towing vehicle and the trailer cooperate and drive on the horizontal flat ground and the deviation angle is zero, the trailer extends between two parallel vertical limit planes, the two limit planes being moreover transverse to the extension direction of the trailer, the rear areas are located between the two limit planes.

This arrangement makes it possible to reduce the area obscured by the trailer in the image from the rear cameras. The rear cameras are also close to the rear end of the towing vehicle.

According to one aspect of the invention, each lateral screen comprises a first display part for the image from the lateral camera and/or the image from the corresponding rear camera and at least one separate second display part for a cropped image from the lateral camera or an image from a corresponding additional lateral camera.

This display in at least two areas is advantageous when the image from the lateral camera is not visible to the driver, that is to say greater that the limit value. The second display part also provides an additional safety element by displaying a rear lateral area from a wide angle.

According to one possibility, each lateral screen comprises a third display part dedicated to displaying the image from the corresponding rear camera.

According to one aspect of the invention, the cropped image from the lateral camera is cropped by the control unit at a wider angle than the image from the lateral camera intended to be displayed on the first display part.

In other words, the lateral camera has an angle wide enough to allow the obtention, by processing of the control unit, of an image of a reduced angle for the first display part and of a cropped image of a non-reduced angle for the second display part.

This arrangement allows only one camera to be used per side, namely the lateral camera, to obtain two differently cropped images.

According to one aspect of the invention, the rear-view system comprises two additional lateral cameras, each additional lateral camera being configured to be attached to a corresponding side of the towing vehicle relative to the longitudinal axis of the towing vehicle.

Preferably, the field of view of each additional lateral camera 15 is different from that of each corresponding lateral camera. These two fields of view can cover common areas.

According to one aspect of the invention, the image from each lateral camera corresponds to the image of a conventional rear-view mirror and the image from each additional lateral camera corresponds to the image of an additional rear-view mirror oriented differently, in particular an additional rear-view mirror required for an articulated vehicle.

The rear-view system is therefore self-sufficient and only the lateral screens are required by the driver when the deviation angle is less than the limit value.

According to one aspect of the invention, the rear-view system comprises two lateral housings, each lateral housing comprising the lateral camera and the corresponding additional lateral camera and each lateral housing being capable of being attached to a corresponding lateral area of a cab of the towing vehicle.

Grouping the two cameras in a housing makes them easier to integrate while limiting the footprint.

Alternatively, in the absence of an additional lateral camera, the same type of lateral housing can be used for the lateral camera alone.

According to one aspect of the invention, the two rear cameras are located in the same vertical rear plane of the towing vehicle and are oriented substantially parallel to the longitudinal axis.

Preferably, the rear plane is transverse to the longitudinal axis.

According to one aspect of the invention, the control unit is capable of determining the distance of an object present in the images of the two rear cameras by comparing the two images and using the principle of stereoscopy.

This arrangement is useful when an obstacle is detected while carrying out a maneuver since it is possible to determine its distance from the rear cameras.

Preferably, the rear cameras are wide-angle cameras so that their fields of view overlap widely.

According to one aspect of the invention, the control unit is configured to be mounted in the towing vehicle. Preferably, the control unit is connected to a central unit of the towing vehicle.

According to one aspect of the invention, the central unit provides the control unit with the value of the deviation angle.

According to one embodiment, the control unit can estimate a value of the deviation angle by analyzing the images from the lateral cameras and/or rear cameras.

According to a particularly advantageous embodiment, the control unit can estimate a value of the deviation angle by an image analysis method coupled with a method using a geometric model based on calculation algorithms.

According to this particularly advantageous embodiment, the image analysis method is based as input on the images captured by the various cameras, and in particular by the lateral cameras, of the vehicle. The images received are processed by the control unit in particular by means of at least one depth estimation method. This processing allows the control unit to determine the geometry of the vehicle, and in particular the geometry of the trailer so as to be able to carry out a first estimate of an end-of-trailer position, that is to say of a location where the end of the trailer is located.

This image analysis method is advantageously supplemented by a method using a geometric model also making it possible to determine an end-of-trailer position and therefore to estimate the deviation angle.

The method using a geometric model is based on dynamic data provided by the central unit of the towing vehicle such as vehicle speed, wheel and/or steering wheel angle as well as on predetermined data such as a trailer size and in particular a predetermined trailer length. Based on these different data, the control unit carries out a second estimate of an end-of-trailer position.

Said first and second estimates of an end-of-trailer position are then compared with each other. If the difference is too large, the first estimate, obtained by image analysis, is used to carry out another estimate of an end-of-trailer position based on the method using a geometric model. More precisely, the first estimate is used to redefine the value of the length of the trailer on the basis of which the method using a geometric model is performed, which makes it possible to carry out a calibration of the geometric model and the data involved, and in particular of the data relating to the predetermined length of the trailer.

Thus, another second estimate of an end-of-trailer position based on the method using a geometric model is then carried out, then compared to the first estimate obtained by image analysis. As long as the difference is too large, or the obtained estimates are incompatible with each other, a new second estimate based on the method using a geometric model is carried out.

When the first estimate and the second estimate are close enough to be considered consistent with each other, the control unit deduces therefrom a final estimate of an end-of-trailer position, which is then used to estimate the deviation angle formed by the extension direction of the trailer relative to the longitudinal axis of the towing vehicle.

In addition, and in certain specific cases, the second estimate obtained by the method using a geometric model makes it possible to detect and correct a particularly gross inconsistency in the first estimate obtained by image analysis, which may, for example, be the case when visibility conditions are particularly poor.

Thus, the image analysis method and the method using a geometric model complement each other and allow the obtained end-of-trailer position estimates to be gradually refined, to arrive at the final estimate used to deduce the value of the deviation angle.

By taking advantage of the images captured by the cameras of the towing vehicle and of certain data received from the central unit of the towing vehicle, this particularly advantageous embodiment therefore makes it possible to carry out a precise and reliable estimate of the deviation angle on the basis solely of an image analysis and a geometric model, without the need to use one or several additional sensors, such as yaw angle detectors or ultrasonic sensors.

According to one aspect of the invention, each rear camera is configured to be attached to or provided in a rear skirt of the towing vehicle.

The rear skirt is a fixed vertical outer element of the towing vehicle, forming a rear partition.

Preferably, each rear camera is disposed vertically at the same level as the axles of the towing vehicle and/or behind the axles along the longitudinal axis.

According to one aspect of the invention, each rear camera is an independent element capable of communicating by wired or wireless communication with the control unit.

Preferably, each rear camera includes a fastening hook capable of cooperating with the rear skirt. The rear cameras can thus be fitted to a large number of towing vehicles during manufacture or retrofit.

By independent element, it is understood that each rear camera is included in its own housing independent of other parts of the towing vehicle.

According to one aspect of the invention, each rear camera comprises an arrangement for fastening to a complementary arrangement of the towing vehicle.

Similarly, each lateral camera and additional lateral camera is capable of communicating via wired or wireless communication with the control unit.

According to one possibility, the present invention also relates to a rear-view and lighting system comprising a rear-view system as described above, the rear-view and lighting system further comprising, for each side, a lateral taillight, each corresponding rear camera being able to communicate with the control unit.

This arrangement facilitates the integration of the rear cameras for the new towing vehicles. Integrating the rear cameras into the lateral taillights reduces the space taken up by the rear camera and looks aesthetically pleasing.

According to one aspect of the invention, by light rear light is meant a rear lighting light and brake light of the towing vehicle.

According to one aspect of the invention, each lateral taillight comprises a support for bulbs and for the corresponding rear camera and a translucent protective capsule mounted on the support and enveloping the bulbs and the rear camera, the protective capsule having an opening for the passage of a lens of the rear camera.

The rear camera is thus protected by leaving only the lens protruding. The opening is provided in a recess in the protective capsule towards the inside of the lateral taillight.

Preferably, mounting the protective capsule on the support provides sealing within the protective capsule and the support. The lateral taillight comprises a sealing device such as a seal for the lens.

According to one aspect of the invention, the support comprises a printed circuit extending transversely to the orientation directions of the bulbs and of the rear camera, the bulbs and the rear camera being attached to the printed circuit.

The present invention also relates to a towing vehicle comprising a rear-view system or a rear-view and lighting system as described above.

The present invention further relates to the articulated vehicle comprising the towing vehicle and the trailer.

The different aspects defined above, which are not incompatible, can be combined.

### BRIEF DESCRIPTION OF THE FIGURES

The invention will be better understood with the aid of the detailed description which is disclosed below with reference to the accompanying drawings.

FIG. 1 is a schematic side view of a trailer and of a towing vehicle comprising a rear-view system.

FIG. 2 is a schematic top view of the trailer and of the towing vehicle during a turn or maneuver.

FIG. 3 is a schematic top view of the towing vehicle comprising the rear-view system.

FIG. 4 is a schematic view of the elements constituting the rear-view system.

FIG. 5 is a schematic rear view of a lateral taillight comprising a rear camera of the rear-view system.

FIG. 6 is a schematic sectional view of the lateral taillight comprising the rear camera.

FIG. 7 is a block diagram representing the method for estimating the deviation angle.

### DESCRIPTION WITH REFERENCE TO THE FIGURES

In the detailed description which follows of the figures defined above, the same elements or elements fulfilling identical functions may retain the same references so as to simplify the understanding of the invention.

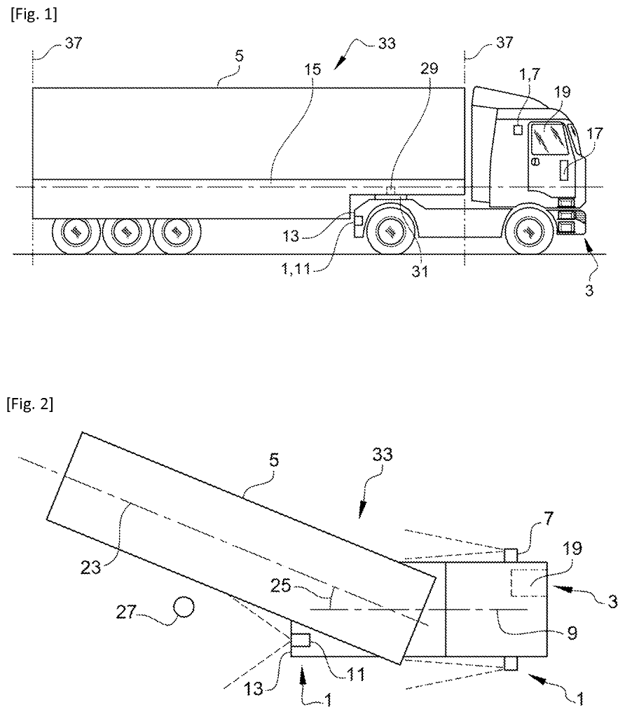

As illustrated in FIGS. 1 to 4, a rear-view system 1 is intended for a towing vehicle 3 capable of cooperating with a trailer 5 mounted mobile in rotation on the towing vehicle 3.

The rear-view system 1 comprises two lateral cameras 7, each lateral camera 7 being configured to be attached to a corresponding side of the towing vehicle 3 relative to a longitudinal axis 9 of the towing vehicle 3.

The rear-view system 1 comprises two rear cameras 11, each rear camera 11 being configured to be attached to a corresponding rear area 13 of the towing vehicle 3.

Each rear area 13 is located on a corresponding side relative to the longitudinal axis 9 and each rear camera 11 being located lower than a load support tray 15 of the trailer 5 when the towing vehicle 3 and the trailer 5 cooperate and drive on a horizontal flat ground.

The rear-view system 1 comprises two lateral screens 17, each lateral screen 17 being configured to be attached to the towing vehicle 3 so as to be visible from a cockpit 19 of the towing vehicle 3.

The rear-view system 1 comprises a control unit 21 configured to display the images from each lateral camera 7 on a corresponding lateral screen 17.

The control unit 21 is further configured to display the image from a rear camera 11 instead of all or part of the image from a lateral camera 7 on one of the two sides when the trailer 5, which is mounted mobile in rotation, extends on the opposite side relative to the longitudinal axis 9.

This occurs when an extension direction 23 of the trailer 5 has a deviation angle 25 greater than a limit value relative to the longitudinal axis 9 of the towing vehicle 3.

The control unit 21 makes it possible the lateral cameras 7 to be displayed when the towing vehicle 3 and the trailer 5 are aligned along the longitudinal axis 9 and when the trailer 5 deviates slightly.

In this case, the trailer 5 does not impair the vision since the lateral cameras 7 film the sidewalls of the trailer 5 on each side. In addition, the front of the trailer 5 which faces the rear of the towing vehicle 3 does not obstruct part of the field of view of the lateral cameras 7. The rear cameras 11 are therefore not used.

The field of view of each lateral camera 7 corresponds to an angle of rear lateral view relative to the towing vehicle 3 driving in the forward direction along the longitudinal axis 9.

When the towing vehicle 3 turns or during a maneuver, a deviation angle 25 appears between the extension direction 23 of the trailer 5 and the longitudinal axis 9 of the towing vehicle 3.

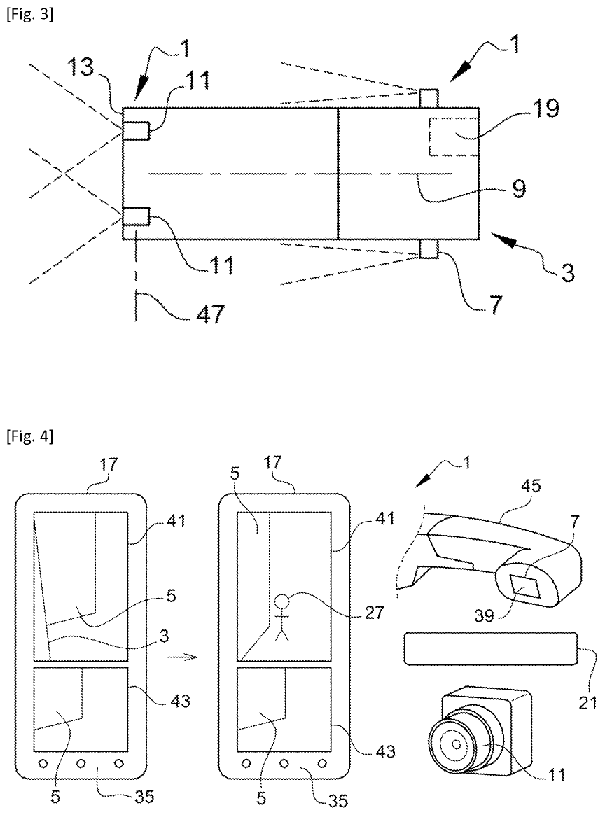

As represented in FIGS. 2 and 4, beyond the limit value of the deviation angle 25 on one side of the longitudinal axis 9, the control unit 21 displays the image from the rear camera 11 on the opposite side.

In fact, on the side of the deviation, the sidewall of the trailer 5 remains visible and occupies more and more space in the field of view of the lateral camera 7.

On the other hand, on the other side, the sidewall of the trailer 5 is less and less visible until it disappears from the field of view of the lateral camera 7. The front of the trailer 5 above the load support tray 15 can also partially obstruct the field of view of the lateral camera 7.

The control unit 21 then changes the display and the rear camera 11 makes visible a field of view hidden by the front of the trailer 5 for the lateral camera 7. The rear camera 11 also makes visible an area that the trailer 5 would occupy if there were no deviation.

If a pedestrian 27 or another vehicle is in this area, it becomes visible on the corresponding lateral screen 17.

When the turn or maneuver is completed and when the deviation angle 25 is again less than the limit value, the control unit 21 replaces the image from the rear camera 11 with that from the lateral camera 7.

The terms “front” and “rear” are to be understood as being defined in relation to the forward direction of travel of the towing vehicle 3 and of the trailer 5 when they cooperate. For the trailer 5, these terms are defined in relation to the extension direction 23 of the trailer 5 and, for the towing vehicle 3, in relation to the longitudinal axis 9.

Optionally, it is possible to configure the control unit 21 so that at least one additional criterion must be met for the image change from the lateral camera 7 to the rear camera 11.

An additional criterion preferably used is the fact that the towing vehicle 3 is driving in the backward direction.

The rear-view system 1 is in this case reserved for maneuvers in the backward direction and the camera change does not occur when driving in the forward direction during tight turns. This arrangement is interesting in the sense that driving in the forward direction remains identical for the driver who constantly sees the images from the lateral cameras 7.

An additional criterion can also be a speed slower than a speed limit, for example 30 km/h.

The trailer 5 comprises a coupling bolt 29 attached to the load support tray 15 and oriented downwards. The towing vehicle 3 comprises a fifth wheel 31 arranged to cooperate with the coupling bolt 29.

The expression “located lower than a load support tray 15” means that directly above each rear camera 11, the load support tray 15 is above the rear camera 11.

The terms “horizontal” and “vertical” and their derivatives are defined when the towing vehicle 3 and the trailer 5 cooperate and drive on the horizontal flat ground.

The limit value is comprised between 5 and 30° depending on the towing vehicle 3 and the trailer 5 used. The limit value can be modified by parametrizing the control unit.

Each lateral camera 7 is disposed on or provided in a lateral part of a body of the towing vehicle 3. Each rear camera 11 is provided in a rear part of the body of the towing vehicle 3. Each lateral part extends substantially parallel to the longitudinal axis 9 and each rear part extends transversely to the longitudinal axis 9.

In the present text, an articulated vehicle 33 is a vehicle comprising the towing vehicle 3 and the trailer 5 mounted mobile in rotation on the towing vehicle 3. It may be a truck or any other type of articulated vehicle.

Each lateral screen 17 comprises a user interface 35 to force the image change between the lateral camera 7 and the rear camera 11. Without user intervention, the display change is carried out automatically by the control unit 21.

The control unit 21 is configured to control the presence of the trailer 5 from the images from the rear cameras 11. The rear cameras 11 can be used by the control unit 21 as a reversing camera in the absence of the trailer 5.

When the towing vehicle 3 and the trailer 5 cooperate and drive on the horizontal flat ground and the deviation angle 25 is zero, the trailer 5 extends between two parallel vertical limit planes 37.

The two limit planes 37 are also transverse to the extension direction 23 of the trailer 5, the rear areas 13 being located between the two limit planes 37.

The rear cameras 11 are also close to the rear end of the towing vehicle 3.

The rear-view system 1 comprises two additional lateral cameras 39, each additional lateral camera 39 being configured to be attached to a corresponding side of the towing vehicle 3 relative to the longitudinal axis 9 of the towing vehicle 3.

Each lateral screen 17 comprises a first display part 41 for the image from the corresponding lateral camera 7 or rear camera 11 and a separate second display part 43 for the image from the corresponding additional lateral camera 39.

The field of view of each additional lateral camera 39 is different from that of each corresponding lateral camera 7. These two fields of view can cover common areas.

The image from each lateral camera 7 corresponds to the image of a conventional rear-view mirror and the image from each additional lateral camera 39 corresponds to the image of an additional rear-view mirror oriented differently, in particular an additional rear-view mirror required for an articulated vehicle.

The rear-view system 1 comprises two lateral housings 45, each lateral housing 45 comprising the corresponding lateral camera 7 and additional lateral camera 39.

Each lateral housing 45 is capable of being attached to a corresponding lateral area of a cabin of the towing vehicle 3.

Alternatively, the rear-view system 1 cannot comprise an additional lateral camera 39. The same type of lateral housing 45 can be used for the lateral camera 7 only.

In this case, the second display part 43 broadcasts a cropped image obtained from the lateral camera 7. Said image is cropped by the control unit 21 according to a wider angle than the image from the lateral camera 7 intended to be displayed on the first display part 41.

In other words, the lateral camera 7 has an angle wide enough to allow the obtention, by processing of the control unit 21, of an image of a reduced angle for the first display part 41 and of a cropped image of a non-reduced angle for the second display part 43.

This arrangement allows only one camera to be used per side, namely the lateral camera 7, to obtain two differently cropped images.

The two rear cameras 11 are located in the same vertical rear plane 47 of the towing vehicle 3 and are oriented substantially parallel to the longitudinal axis 9. The rear plane 47 is transverse to the longitudinal axis 9.

The control unit 21 is capable of determining the distance of an object present in the images of the two rear cameras 11 by comparing the two images and using the principle of stereoscopy.

The rear cameras 11 are wide-angle cameras so that their field of view overlaps widely. The control unit 21 is configured to be mounted in the towing vehicle 3. The control unit 21 is connected to a central unit of the towing vehicle 3.

The central unit can provide the control unit 21 with the value of the deviation angle 25. Also, the control unit 21 can estimate a value of the deviation angle 25 by analyzing the images from the lateral cameras 7 or rear cameras 11.

As represented in FIG. 7, the control unit 21 can also estimate a value of the deviation angle by an image analysis method coupled with a method using a geometric model. The image analysis method is based as input on the images captured by the different, lateral and rear, cameras of the towing vehicle 3. The received images are processed by the control unit 21 by means in particular of a depth estimation method. This processing allows the control unit 21 to determine the geometry of the articulated vehicle 33, and in particular the geometry of the trailer 5 so as to be able to carry out a first estimate of an end-of-trailer position 5, that is to say of a location where the end of the trailer is located.

This image analysis method is advantageously supplemented by a method using a geometric model also making it possible to determine an end-of-trailer position.

The method using a geometric model is based on dynamic data provided by the central unit of the towing vehicle 3 such as the speed of the towing vehicle 3, the wheel and/or steering wheel angle as well as on predetermined data such as a trailer size and in particular a predetermined trailer length. On the basis of these different data and by means of a geometric model, the control unit 21 carries out a second estimate of an end-of-trailer position.

Said first and second estimates of an end-of-trailer position are then compared with each other. If the difference is too large, the first estimate, obtained by image analysis, is used to carry out another estimate of an end-of-trailer position based on the method using a geometric model. More precisely, the first estimate is used to redefine the value of the length of the trailer on the basis of which the method using a geometric model is performed, which makes it possible to carry out a calibration of the geometric model and the data involved, and in particular of the data relating to the predetermined length of the trailer.

Thus, another second estimate of an end-of-trailer position based on the method using a geometric model is then carried out, then compared to the first estimate obtained by image analysis. As long as the difference is too large, or the obtained estimates are incompatible with each other, a new second estimate based on the method using a geometric model is carried out.

When the first estimate and the second estimate are close enough to be considered consistent with each other, the control unit 21 deduces therefrom a final estimate of an end-of-trailer position, which is then used to estimate the deviation angle formed by the extension direction of the trailer 5 relative to the longitudinal axis of the towing vehicle 3.

In addition, and in certain specific cases, the second estimate obtained by the method using a geometric model makes it possible to detect and correct a particularly gross inconsistency in the first estimate obtained by image analysis, which may, for example, be the case when visibility conditions are particularly poor.

The programming of the control unit 21 can be modified to adapt the limit value of the deviation angle 25.

Each rear camera 11 is configured to be attached to or provided in a rear skirt of the towing vehicle 3.

The rear skirt is a fixed vertical outer element of the towing vehicle 3, forming a rear partition. Each rear camera 11 is disposed vertically at the same level than the axles of the towing vehicle 3 and/or behind the axles along the longitudinal axis 9.

As illustrated in FIG. 4, each rear camera 11 is an independent element capable of communicating by wired or wireless communication with the control unit 21.

In FIG. 4, only the lateral camera 7, the additional lateral camera 39, the rear camera 11 and the lateral screen 17 relating to a single side are represented. The left lateral screen 17 represents the situation before the rear camera 11 is displayed and the right lateral screen 17 represents this same screen when the rear camera 11 is displayed.

Each rear camera 11 includes a fastening hook capable of cooperating with the rear skirt. The rear cameras 11 can thus be fitted to a large number of towing vehicles 3 during manufacture or retrofit.

By independent element, it is understood that each rear camera 11 is included in its own housing independent of other parts of the towing vehicle 3.

Each rear camera 11 comprises an arrangement for fastening to a complementary arrangement of the towing vehicle 3.

Similarly, each lateral camera 7 and additional lateral camera 39 is capable of communicating by wired or wireless communication with the control unit 21.

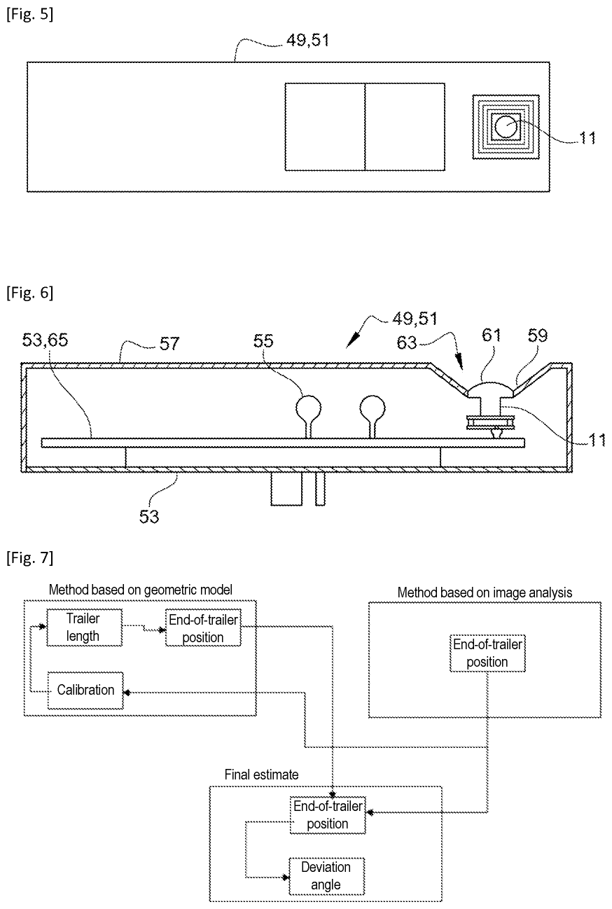

As illustrated in FIGS. 5 and 6, alternatively to the rear cameras 11 as independent elements, each rear camera 11 can be included in a corresponding lateral taillight 49.

We then obtain a rear-view and lighting system 51 similar to the rear-view system 1 above and further comprising, for each side, a lateral taillight 49.

Each rear camera 11 is capable of communicating with the control unit 21.

This arrangement facilitates the integration of the rear cameras 11 for the new towing vehicles. The integration of the rear cameras 11 into the lateral taillights 49 reduces the space taken up by the rear camera 11 and has an aesthetic appearance.

By lateral taillight 49 is meant a rear lighting light and brake light of the towing vehicle 3.

Each lateral taillight 49 comprises a support 53 for bulbs 55 and for the corresponding rear camera 11 and a translucent protective capsule 57 mounted on the support 53 and enveloping the bulbs 55 and the rear camera 11.

The protective capsule 57 has an opening 59 for the passage of a lens 61 of the rear camera 11.

The rear camera 11 is thus protected by leaving only the lens 61 protruding. The opening 59 is provided in a recess 63 of the protective capsule 57 towards the inside of the lateral taillight 49.

Mounting the protective capsule 57 on the support 53 ensures sealing within the protective capsule 57 and the support 53. The lateral taillight 49 comprises a sealing device such as a seal for the lens 61.

The support 53 comprises a printed circuit 65 extending transversely to the orientation directions of the bulbs 55 and of the rear camera 11, the bulbs 55 and the rear camera 11 being attached to the printed circuit 65.

The present invention also relates to a towing vehicle 3 comprising a rear-view system 1 or a rear-view and lighting system 51 as described above.

The present invention further relates to the articulated vehicle 33 comprising the towing vehicle 3 and the trailer 5.

This above description highlights the fact that the camera change operated by the control unit 21 makes it possible to improve safety and facilitates the turns and maneuvers of the articulated vehicle 33. The area obstructed by the trailer 5 is limited thanks to the image from the opposite rear camera.

Furthermore, the rear-view system 1 or the rear-view and lighting system 51, if applicable, is thus self-sufficient. The driver does not have to look at other additional screens to ensure his safety during a maneuver or a turn.

It goes without saying that the invention is not limited to the single embodiment described above as an example; on the contrary, it encompasses all variants thereof.

1. A rear-view system for a towing vehicle capable of cooperating with a trailer mounted mobile in rotation on the towing vehicle, the rear-view system comprising:
two lateral cameras, each lateral camera being configured to be attached to a corresponding side of the towing vehicle relative to a longitudinal axis of the towing vehicle,
two rear cameras, each rear camera being configured to be attached to a corresponding rear area of the towing vehicle, each rear area being located on a corresponding side relative to the longitudinal axis, each rear camera being located lower than a load support tray of the trailer when the towing vehicle and the trailer cooperate and drive on a horizontal flat ground,
two lateral screens, each lateral screen being configured to be attached to the towing vehicle so as to be visible from a cockpit of the towing vehicle,
a control unit configured to display the images from each lateral camera on a corresponding lateral screen, the control unit being further configured to display the image from a rear camera instead of the image from a lateral camera of one of the two sides when the trailer, which is mounted mobile in rotation, extends on the opposite side relative to the longitudinal axis, an extension direction of the trailer having a deviation angle greater than a limit value relative to the longitudinal axis of the towing vehicle.

2. The rear-view system according to claim 1, wherein, when the towing vehicle and the trailer cooperate and drive on the horizontal flat ground and the deviation angle is zero, the trailer extends between two parallel vertical limit planes, the two limit planes being moreover transverse to the extension direction of the trailer, the rear areas are located between the two limit planes.

3. The rear-view system according to claim 1, wherein each lateral screen comprises a first display part for the image from the corresponding lateral camera or rear camera and a separate second display part for a cropped image from the lateral camera or an image from a corresponding additional lateral camera.

4. The rear-view system according to claim 3, wherein the cropped image from the lateral camera is cropped by the control unit at a wider angle than the image of the lateral camera intended to be displayed on the first display part.

5. The rear-view system according to claim 3, comprising two additional lateral cameras, each additional lateral camera being configured to be attached to a corresponding side of the towing vehicle relative to the longitudinal axis of the towing vehicle.

6. The rear-view system according to claim 5, comprising two lateral housings, each lateral housing comprising the lateral camera and the corresponding additional lateral camera and each lateral housing being capable of being attached to a corresponding lateral area of a cabin of the towing vehicle.

7. The rear-view system according to claim 1, wherein the two rear cameras are located in the same vertical rear plane of the towing vehicle and are oriented substantially parallel to the longitudinal axis.

8. The rear-view system according to claim 1, wherein the control unit is capable of determining the distance of an object present on the images of the two rear cameras by comparing the two images and using the principle of stereoscopy.

9. The rear-view system according to claim 1, wherein each rear camera is configured to be attached to or provided in a rear skirt of the towing vehicle.

10. The rear-view system according to claim 1, wherein each rear camera is an independent element capable of communicating by wired or wireless communication with the control unit.

11. A rear-view and lighting system comprising a rear-view system according to claim 1, the rear-view and lighting system further comprising, for each side, a lateral taillight each corresponding rear camera being able to communicate with the control unit.

12. The rear-view and lighting system according to claim 11, wherein each lateral taillight comprises a support for bulbs and for the corresponding rear camera and a translucent protective capsule mounted on the support and enveloping the bulbs and the rear camera, the protective capsule having an opening for the passage of a lens of the rear camera.

13. The rear-view and lighting system according to claim 12, wherein the support comprises a printed circuit extending transversely to the orientation directions of the bulbs and of the rear camera, the bulbs and the rear camera being attached to the printed circuit.
